(19) United States
(12) Patent Application Publication
(10) Pub. No.: US 2008/0134321 A1
(43) Pub. Date: Jun. 5, 2008

(54) Tamper-resistant method and apparatus for verification and measurement of host agent dynamic data updates

(76) Inventors: Priya Rajagopal, Shrewsbury, MA (US); Travis Schluessler, Hillsboro, OR (US); Uday R. Savagaonkar, Beaverton, OR (US); David Durham, Hillsboro, OR (US); Ravi Sahita, Beaverton, OR (US); Uri Blumenthal, Fair Lawn, NJ (US)

Correspondence Address: Blakely, Sokoloff, Taylor & Zafman LLP;7th Floor, 12400 Wilshire Boulevard, Los Angeles, CA, 90025, US

(21) Appl. No.: 11/648,252

(22) Filed: Dec. 29, 2006

Related U.S. Application Data
(60) Provisional application No. 60/873,064, filed on Dec. 5, 2006.

(51) Int. Cl. H04L 9/32

(52) U.S. Cl. 726/21

(57) ABSTRACT

A platform for verifying the validity of changes to dynamic data modifiable during the runtime execution of an agent. In one embodiment, a management mode of a processor uses key information to generate a signature for a set of dynamic data, the signature to verify the validity of the state of the dynamic data to an integrity measurement agent.

### RELATED APPLICATIONS

The present application claims the benefit of priority under 35 U.S.C. § 119(e) to U.S. Provisional Application No. 60/873,064, filed Dec. 5, 2006.

### BACKGROUND OF THE INVENTION

1. Field of the Invention

Embodiments of the invention relate to electronic system security, and more specifically to verifying the integrity of changes to dynamic data stored in a memory.

2. Background Art

Software programs are subject to complex and evolving attacks by malware seeking to gain control of computer systems. These attacks can take on a variety of different forms ranging from attempts to crash the software program to subversion of the program for alternate purposes. Advanced attacks may attempt to alter dynamic data in memory which is subject to modification during the runtime of a software program. This dynamic data may contain critical information that would need to be protected against malware attempting to tamper with the data. Examples of dynamic data include data in network packet buffers associated with a network driver, packet filter rules associated with firewall software, anti-virus software version information and data in buffers that hold status and health information of a software program. Hence, it is crucial to ensure the integrity of any changes to this dynamic data.

Active observation methods exist to determine whether a code image of a program has been changed from its original state—i.e. as loaded from a non-volatile storage into a memory. Typically, a measurement engine performs this active platform observation by referring to an integrity manifest which indicates an initial state of the program's source code as loaded from non-volatile storage into a memory. The measurement engine determines whether a program's image has been modified based on a comparison of an evaluation of the image in memory to the initial state indicated in the integrity manifest. Appropriate remedial action can be triggered if modification of the program's image is detected. Previously, these observation methods have been limited to verifying the integrity of executable code and static information as initially loaded into a memory. The increasing sophistication of malware attacks increases the threat to the integrity of dynamic data as it changes throughout the runtime of a software program.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a host system capable of implementing an embodiment of the invention.

FIG. 2 is a block diagram illustrating an active observation method to protect updates to dynamic data according to an embodiment of the invention.

FIG. 3 is a block diagram illustrating a use of key information to verify the integrity of updates to dynamic data.

FIG. 4 is a flow diagram illustrating a method of verifying the integrity of changes to dynamic data associated with a host agent.

FIG. 5 is a swim lane diagram illustrating a token-based protocol used to enable authorized updates to a set of dynamic data by a host agent.

FIG. 6 is a swim lane diagram illustrating an embodiment of the invention wherein a host agent computes a signature over a set of dynamic data.

### DETAILED DESCRIPTION

An embodiment of the invention provides verification of changes to a set of dynamic data. The dynamic data may be subject to change as a result of runtime execution of an agent (“host agent” or “HA”)—such as a software program, device driver, etc.—running on a host platform. A verification entity, herein referred to as the Integrity Measurement Module (IMM), is responsible for verifying a validity of a change to the set of dynamic data—i.e. verifying that no unauthorized change has been made to the dynamic state of a host agent running on a host system. As used herein, “verifying a validity” may include, but is not limited to, verifying that the integrity of the set of dynamic data in its given state represents the latest authorized changed state of said set of dynamic data, and/or authenticating the agent causing or otherwise associated with the latest changed state as being a properly authorized agent. Authenticating the agent may, for example, include verifying a location in memory of a code image of the agent based on an expected location of the code image. Authenticating the agent may alternately or additionally include, for example, validating the integrity of the code image of the agent in memory. In order to ensure that the IMM itself is secure from malware attacks, it may reside in a partition—such as a Service Processor, embedded microcontroller, or virtualized partition—which is isolated at least from the host agent itself. Isolation from the host agent may include isolation from the normal operating mode of the processing unit in which the host agent is running. Updates to dynamic data sets belonging to a host agent may be initiated locally by the host agent itself or may be initiated by a remote management console. The mechanisms discussed herein may handle either case.

To securely change dynamic data, an HA may leverage a System Management Mode (SMM) or similar management technologies to provide key information to verify changes to a dynamic data set accessible to the HA. “SMM” and “management mode” are used herein to refer to any high-privilege processor mode wherein normal execution of one or more programs—such as an operating system (OS)—is suspended, and special separate software (usually firmware or a hardware-assisted debugger) is executed. The Intel® IA-32 microprocessor instruction set is one example of an architecture which is capable of supporting such a management mode.

Various embodiments of the invention relate to changing the state of a set of dynamic data which is accessible to an HA executing on a host system. This change may be caused by a runtime operation of the HA itself or, for example, by an administrator having authorization to make such changes. The host system has a normal operating mode in which the HA executes, and an SMM, wherein the HA relinquishes or otherwise suspends some control of the host system. In the course of the changing of the set of dynamic data, the SMM may provide any of a variety of security services to the HA. According to techniques described herein, the SMM of the host system and an IMM, which is isolated from the HA, exchange key information which may be used to verify the validity of changes to dynamic data. Verification of the validity of dynamic data may include using the exchanged key information to compare information related to a current state of dynamic data with information related to a previous changed state of said dynamic data. Where security services are provided by the SMM in the course of changing the set of dynamic data, the exchanged key information may include keys related to the security services provided. Some of these exchanged keys may be used, for example, according to traditional data encryption/decryption methods. Alternately or in addition, key information may be used to provide and/or verify a data signature for the changed state of dynamic data. For illustrative purposes, the embodiments described herein detail the use of key information to verify the validity of data signatures for a changed state of dynamic data. It is understood, however, that the use of exchanged key information according to various other embodiments of the invention may be extended to other combinations of security services of an SMM.

According to one embodiment of the invention, the SMM may be used to sign the updates to the dynamic data sets in a secure and non-spoofable manner using keys that are securely stored in System Management Random Access Memory (SMRAM) accessible only to the SMM code. An operating environment which has access to a memory which is isolated from one or more programs in their normal runtime execution and which suspends said normal runtime execution may be leveraged to verify the validity of changes to dynamic data according to embodiments of the invention.

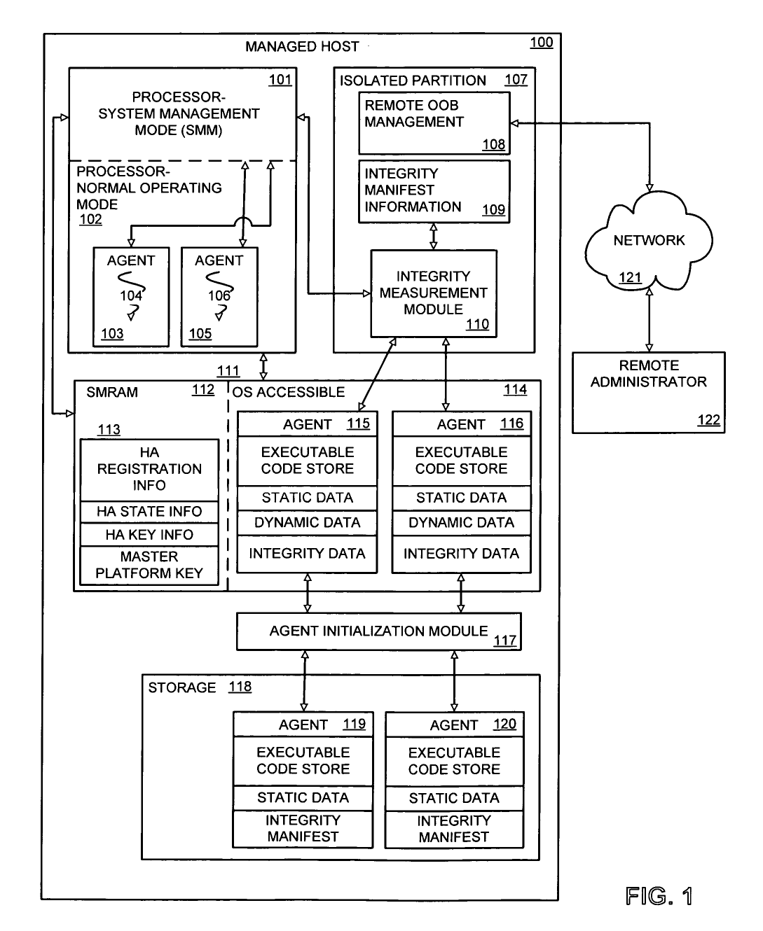

FIG. 1 is a block diagram of an embodiment of a host system with an SMM and an IMM to protect dynamic data for access by an HA. Managed host 100 represents an electronic system or systems that support one or more HAs. Managed system 100 may be, for example, a desktop computer, a laptop computer, a personal digital assistant (PDA) or other handheld computing or communication device, a server, etc. Host system 100 may include a processor having an SMM 101 capable of suspending execution of a normal operating mode 102 of the same processor. Such a processor may represent a processor, microcontroller, central processing unit (CPU), etc. In another embodiment, SMM 101 may be implemented as a dedicated processor capable of suspending another dedicated processor executing in normal operating mode 102. Alternatively, either one or both of SMM 101 and normal operating mode 102 may be implemented as a plurality of processors. For example, the modes 101 and 102 should each be understood as potentially including one or more processing cores or processing units, including parallel processing capability. References herein to a “mode” may be understood to refer to a given device or set of devices operating in or otherwise supporting said mode.

The normal operating mode 102 may execute one or more agents 103 and 105. Such an agent on a managed host 100 may alternately be known as a “host agent” (HA). The number of agents shown is merely representative of the ability to potentially monitor multiple agents, and is not to be understood as necessary or restrictive. Any number of measured agents can be supported, from one to multiple. The constraints on number of measured agents could be, for example, system resource availability of managed host 100, processing cycles available on an integrity management module 110 and/or bandwidth of an interface between modes 101 and 102. Agents 103 and 105 are executed by the normal operating mode 102, and may include individual software programs, kernels, executable threads, etc. Examples of agents include antivirus software, intrusion detection systems (IDSs), firewalls, OS invariants, etc. Each agent 103 and 105 includes a process or executable flow 104 and 106, respectively. The flows 104 and 106 represent various functions that each corresponding agent 103 and 105 may perform, or services that the agents may provide. Agents 103 and 105 are understood to be in execution on the normal operating mode 102, and corresponding versions or sources for the agents is represented in other places in FIG. 1. The significance of each will be described in more detail below.

Managed host 100 includes memory 11, which may store/provide instructions and/or data to use for execution to direct operation and/or functions of the normal operating mode 110. Memory 111 may include random access memory (RAM), and may include one or more of the following: static RAM (SRAM), dynamic RAM (DRAM), synchronous DRAM (SDRAM), dual-data rate RAM (DDRRAM), etc. Memory 111 may include one or more sequences of code and/or data stored therein, and may be referred to as an operating memory. A code sequence can be a set or a group of machine instructions representing one or more function calls, one or more subroutines, or one or more operations. A program or agent may refer herein to any one of these alone, as well as a conjunction of one or more of these.

Managed host 100 also includes storage 118, which represents a non-volatile storage to store persistent data. Non-volatile storage refers to a medium of storage that retains its value even when power is removed from the storage. Persistent data refers to data that is desired to be retained when power is interrupted to managed host 100, for example, system files, operating system(s), program files, configuration files, etc. Storage can include disks and associated drives (e.g., magnetic, optical), universal serial bus (USB) storage devices and associated ports, flash memory, read only memory (ROM), non-volatile semiconductor drives, etc.

In one embodiment storage 118 includes agents 119 and 120, which represent the persistent store of source code for agents 103 and 105, respectively, that are loaded as agents 115 and 116, respectively, to be executed on the normal operating mode 102. Storage 118 may be a storage resource physically part of managed host 100, or it may be a remote storage resource accessible to managed host 100, but not necessarily part of the same physical system. For example, storage 118 could be located over a network. In storage 118, each agent 119 and 120 may include an executable code store that may have executable files or code segments, links to other routines (e.g., a call to a dynamic linked library (DLL)), a data segment, etc. The executable code store provides the functionality of the agent. The agents may also include a static configuration to indicate settings associated with the respective agent. The agents may also include dynamic data, although some or all of the dynamic data may be generated at the time agents 115 and 116 are loaded into memory. In one embodiment one or more programs or agents in storage 118 includes an integrity manifest, as shown for agents 119 and 120. The integrity manifest can be as described above, with one or more integrity check values, data signatures, or other information covering the code store of the agents and/or the static and/or dynamic data associated with the agents.

Although each agent 119 and 120 is understood to be potentially very different, the operation on the agents is similar for purposes of the discussion of monitoring their integrity, so description herein will be limited to agent 119. Agent 119 is loaded from storage 118 into an operating system (OS) accessible region 114 of memory 111 to be able to execute the program. In one embodiment a loader (not shown) performs the loading function(s). In another embodiment, agent initialization module 117 provides for the loading of agent 115 into memory 111. Typically, dynamic data may be loaded into an region 114 of memory 111 which is accessible to an OS executing in the normal mode 102. Agent 115 may include dynamic data subject to modification during run-time operation of the flow 104 for agent 103. An embodiment of the invention provides a secure method to update one or more sets of this dynamic data and to verify the validity of said updates. In varying embodiments of the invention, a system or apparatus may provide this security and verification of changes in the dynamic data of an agent 115.

In one embodiment managed host 100 includes an isolated partition 107 which includes an IMM 110. Isolated partition 107 is understood to be a partition which is isolated at least in part from control by an HA and/or an OS (not shown) supporting the HA during the normal operating mode 102. In one embodiment, isolated partition 107, including IMM 110, may exist as an integral part of the SMM 101, working as part of the management services of a processor. Alternatively, isolated partition 107, including IMM 110, may be external to the physical device represented by managed host 100. IMM 110 may be connected to SMM 101 to exchange key information used to verify the validity of changes to dynamic data of an agent 155 in OS accessible memory 114. This connection may use any of a variety of parallel port connectors such as those which comply with the Institute of Electrical and Electronics Engineers (IEEE) Standard 1284-1994, “IEEE Standard Signaling Method for a Bidirectional Parallel Peripheral Interface for Personal Computers”, released March, 1994. Alternately, this connection may use any of a variety of serial bus connectors, such as a PCI Express® connection, a Serial Advanced Technology Attachment (SATA) connector, or a Universal Serial Bus (USB) connector.

In one embodiment, IMM 110 includes a DMA connection to OS accessible region 114 of memory 111 to obtain information regarding measured agent 115. For example, IMM 110 may read the integrity manifest of the corresponding agent 115 stored in memory 111 to determine that agent 103 is indeed agent 115 of memory 111, and not an imposter as may be generated by an attack. Thus, flow 104 could be verified to be valid and allowed to execute its functions. The DMA connection (not numbered in FIG. 1) represents control logic (hardware and/or software), controllers, buses, etc., to provide access to the loaded program information for agent 115 stored in memory 111 without processing of the information by normal operating mode 102. In this IMM 110 can operate outside the context of an OS or other application executing in normal operating mode 102. In another embodiment, IMM 110 is coupled to integrity manifest information 109 in the isolated partition 107. Integrity manifest information 109 is gathered for those agents 115 and 116 in memory 114 whose integrity is validated by IMM 1110.

In one embodiment, isolated partition 107 may include remote out-of-band (OOB) management 108. OOB management refers to management and/or control of a communication resource that is inaccessible to an OS executing in normal operating mode 102. Remote OOB management 108 refers to a communication link with an entity external to managed host 100 over network 121. The communication link can be wired or wireless, and a wired link could be via twisted pair (e.g., Cat-5), coaxial cable, etc. In one embodiment remote administrator 122 is connected to remote OOB management 108 via network 121. Remote administrator 122 could contain integrity manifest information for use by the IMM 110.

Embodiments of the invention may use a SMM 101 or similar specialized processor mode to protect keying material and the cryptographic functions that utilize this keying material to encrypt/decrypt and/or validate the integrity of dynamic data. The SMM 101 provides a partitioned memory and context in which the keying material is protected from disclosure to other programs running on a host system. Embodiments of the invention increase the security of keying material by providing an isolated and tamper-resistant environment for key storage and processing and, thereby, increase the difficulty for an attacker to obtain the keying material through traditional attack vectors.

The SMM 101 (or similar) specialized processor mode may also provide security services for program data. The term “security services” broadly refers to processes that enhance the security of data such as encryption, decryption, authorization, checking a certification of an agent, integrity checking, and the like. The SMM 101 is a special operating mode that may provide these security services in an isolated environment that is independent of an OS executing in normal operating mode 102. A processor enters the SMM when a System Management Interrupt (SMI) is triggered and executes code and data from a chipset protected region of main memory called System Management Random Access Memory (SMRAM) 112 that is made inaccessible to software executing in other processor operating modes. SMRAM 112 may include information 113 concerning one or more of agents 115 and 116. For example, information 113 may include registration information provided by IMM 110 during registration of an HA. Information 113 may also include current state and key information to be used in securely changing dynamic data according to techniques described herein. In FIG. 1, SMRAM 112 is shown as a separate partition of memory 111.

In an embodiment, the SMM obtains state information from the program that triggers it. In one embodiment, the processor provides a saved state map or similar structure of the general processor registers and state to the SMM when it invokes the SMM. The saved state map (or similar structure) provides information about processor state at the time of invoking the management mode. For example, a program executing in the management mode may recover the program counter of the invoking program from the saved state map (or similar structure). In an embodiment, this provides a tamper proof way to detect the source of the SMI or other SMM invocation which can be traced back to the program or device driver by means of retrieving the program counter and other information useful for identifying the program executing just prior to the SMI. Since dynamic data values of an agent 115 in memory 111 can be overwritten or otherwise modified by an attacking program, it may be desirable to verify or otherwise protect the integrity of changes to that dynamic data.

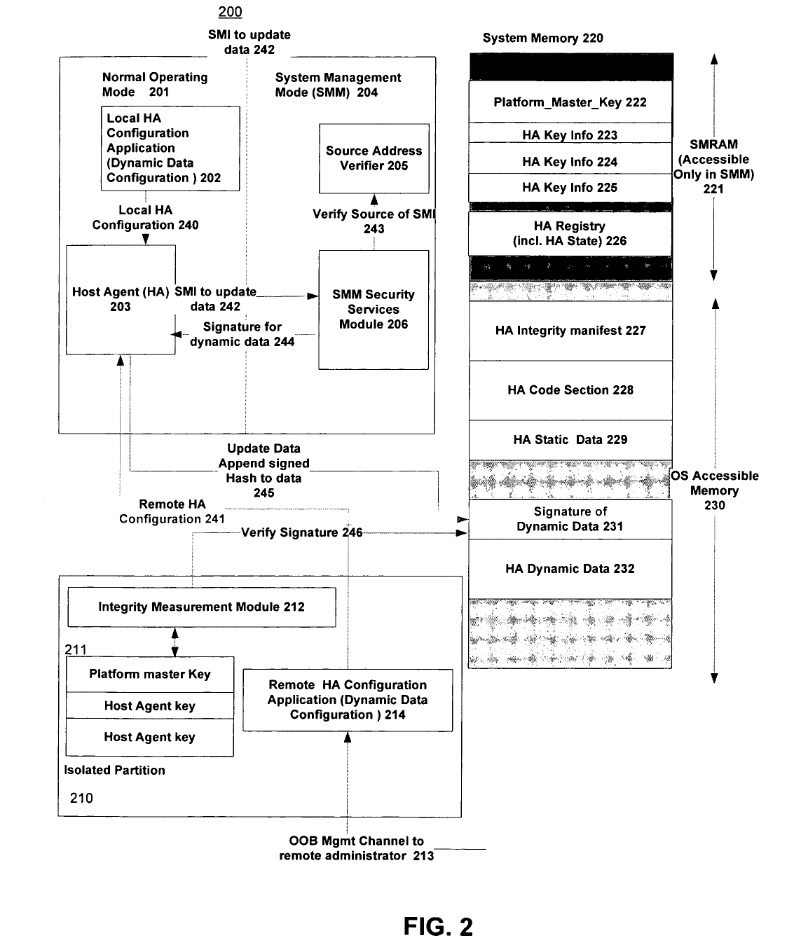

FIG. 2 is a block diagram showing an exchange 200 between HA 203, a system management mode 204 and an IMM 212, wherein an embodiment of the invention protects the integrity of changes to dynamic data 232 of HA 203. Information about HA 203 may be made available to SMM 204 and IMM 212 in the course of configuration of HA 203. Normal operating mode 201 may include local HA configuration application 202, to locally configure HA 203 for runtime execution, at 240. System memory 220 may include an OS accessible memory 230 storing a HA integrity manifest 227, a HA code section 228, HA static data 229, and HA dynamic data 232. In the course of runtime execution, HA 203 may read and/or write to the OS accessible memory 230 of the system memory 220, which in turn may result in one or more changes to dynamic data 232. System memory 220 may further include an SMRAM 221 which accessible only to the SMM 204 and stores key information related to the signing of sets of HA dynamic data 232. In one embodiment, the SMRAM 221 includes Platform_Master_Key 222, a shared key issued to entities capable verifying the validity of changes to dynamic data 232. SMRAM 221 may also include one or more sections of Host Agent Key information 223, 224 and 225, each corresponding to an HA for which SMM 204 is providing security services. SMRAM may further include an HA registry 226, including HA state information for each HA registered by the SMM.

SMM 204 may include SMM security services module 206 to maintain state information corresponding to each supported HA, that is referred to while performing various SMM security services. The per-HA state information 226 is maintained in SMRAM 221 and may include, for example, a unique per-HA identifier HA_ID, the code ranges corresponding to the virtual memory ranges of the images of registered HAs, a counter token_counter that is used to track the number of outstanding tokens for a given HA and a monotonically increasing token_nonce counter used in token generation. The use of token_counter and token_nonce will be elaborated in detail while discussing the dynamic data update process by the HA. This per-HA state information 226 may be created for every HA during registration and removed during deregistration of HA.

According to one embodiment of the invention, isolated partition 210 includes an IMM 212 to verify changes to the dynamic data 232 based at least in part on data signature information, such as that generated by the SMM 204 using key information in SMRAM 221. Isolated partition 210 may include an IMM 212 to verify the integrity of a signature 231 of a set of dynamic data 232. This integrity verification may be based on stored key information 211, which may include a copy of the Platform_Master_Key and/or HA key information for one or more HAs capable of modifying dynamic data 232.

The IMM 212 refers to software/firmware that is responsible for monitoring the validity of changes to dynamic data 232. Note that techniques for validating the integrity of static code and data sections have previously been limited to comparing data to a code image as loaded into memory. By contrast, embodiments of the present invention may further verifying the validity of changes to dynamic data which take place throughout the course of a runtime of an HA. The IMM can be part of an isolated service processor on the platform, a virtual service partition or a virtual machine monitor (VMM). Additionally, the IMM may further be coupled have an out-of-band management channel 213 for configuration of the HA data—for example by a remote administrator. Hence, the IMM is a trusted platform entity. It has services such as the Virtual-to-physical address Mapper (V2P Mapper) for mapping virtual addresses to corresponding physical addresses which it uses to scan the HA Image and in order to validate the integrity of the HA code image.

To securely verify the integrity of changes to dynamic data according to an embodiment of the invention, the HA 203 is first configured by the normal operating mode 201 using a local configuration application 202. This local configuration 240 may include loading into the OS accessible memory 230 of system memory 220 a code image of the HA, including an HA integrity manifest 227, an HA code section 228, HA static data 229, and HA dynamic data 232. Configuration of HA 203 may further include remote configuration 241 of the HA 203 for integrity verification in the isolated partition 210, such as that provided by a remote HA configuration application 214. Remote configuration 241 may include authentication and registration of the HA 203 by the IMM 212 and/or communication of HA registration information to SMM 204 (not shown).

After configuration of HA 203, a set of dynamic data 232 may be modified as a result of runtime execution of HA 203 in normal operating mode 201, for example. During this runtime execution, HA 203 or some other authorized agent may seek to modify dynamic data 232. In an embodiment of the invention, HA 203 may send an SMI 244 to the SMM security services module 206, requesting any of a variety of security services. The SMI may be part of a request to change a set of dynamic data 232 to a given state and to provide a data signature based at least in part on the resulting state of the updated dynamic data 232. The data signature may for example be generated based on a hash function or a message authentication code (MAC) function such as a keyed-hash MAC (HMAC), e.g. Internet Engineering Task Force (IETF) Request for Comments (RFC) No. 2104, “HMAC: Keyed-Hashing for Message Authentication”, February 1997, or a cipher-based MAC (CMAC), e.g. IETF RFC No. 4493 “The AES-CMAC Algorithm”, June 2006. Descriptions herein to a data signature derived from a hash are exemplary, and may be substituted with derivation of a data signature from a MAC function. In response to the SMI, SMM security services module 206 may verify the HA 203 as the source of the SMI, at 243, using a source address verifier 205, for example. Once the HA 203 is verified, the SMM security services module 206 provides the requested security services and/or authorizes the updating of dynamic data 232. Various embodiments of the invention may normalize the execution time for computations in the host system to prevent side-channel attacks. Side-channel attacks are often based on measuring how much time various computations take to perform, which may be frustrated by normalization or otherwise masking these time periods. In addition, various embodiments of the invention may, prior to returning the host system to a normal processor mode, flush any data related to cryptographic or other security operations from processor data caches associated with the management mode. This flushing may prevent malware or an unauthorized agent from accessing security data during the normal operating mode.

Once the set of dynamic data 232 is updated, the SMM security services module 206 sends the signature based at least in part on the resulting state of the dynamic data 232, at 244. The signature of the dynamic data 231 may be appended to the dynamic data 232, at 245, or otherwise stored in the OS accessible memory 230. Once the signature of the dynamic data 231 is in the OS accessible memory 230, the IMM 212 may access the system memory 220 to verify the signature 231, at 246, based at least in part on the key information 211 stored in isolated partition 210.

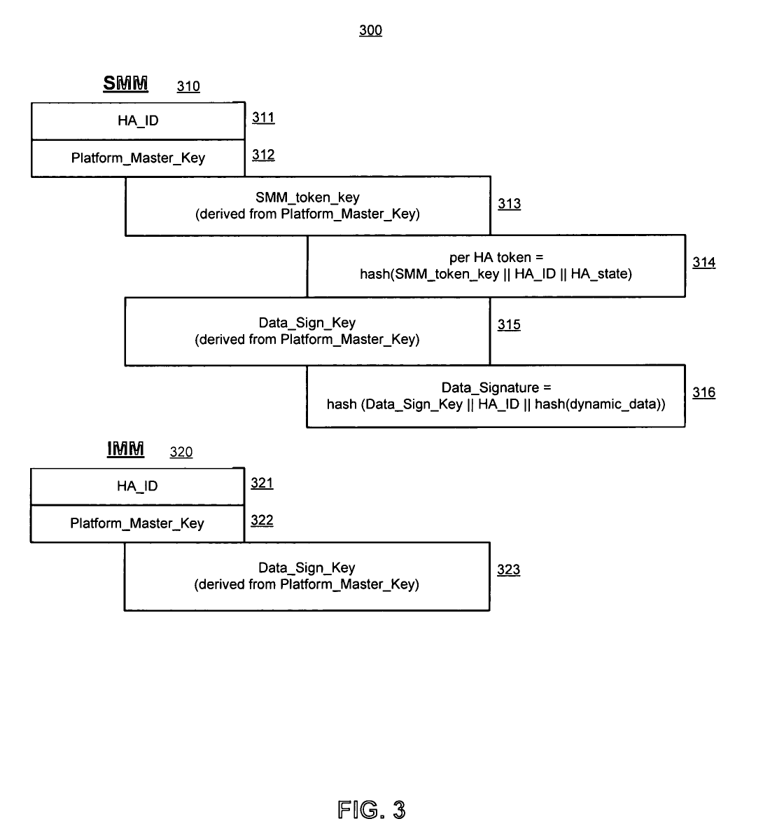

FIG. 3 illustrates how key information 300 is used to validate the integrity of changes to dynamic data according to one embodiment of the invention. The security of key information used to sign a set of dynamic data is crucial. The key information itself may be stored in a secure manner hidden from an HA that can potentially tamper with it. Key information 300 includes key information stored in a SMM 310 and key information stored in an IMM 320. In this embodiment, SMM 310 and IMM 320 are both issued a shared Platform_Master_Key 312 and 322. This key may be provisioned pre-boot time on the SMM 310 (e.g. in an SMM security services module) and on the IMM 320. The Platform_Master_Key 312 and 322 may be used to derive one or more other keys used to sign and/or verify the validity of changes to a set of dynamic data. Furthermore, in the course of configuring an HA for integrity protection of dynamic data, SMM 310 and IMM 320 acquire an HA identifier HA_ID 311 used to derive one or more keys.

The SMM 310 may use the Platform_Master_Key 312 to derive a SMM token_key 313 which is used exclusively by the SMM Security services module for tracking HA state. This key is derived by the SMM security services module during pre-boot from Platform_Master_Key 312 and is known only to the SMM 310. The SMM 310 may use SMM_token_key 313 to generate a unique per-HA token 314. A per-HA token 314 may be used to track a sequence of SMI triggers generated by an HA. The per-HA token 314 may be an integrity check value (ICV) over certain fields associated with a specific HA. The SMM 310 may generate such an ICV based on the HA_ID 311 of the HA and the current state information of the HA, HA_State, for example:

per-HA token=hash (SMM_token_key∥HA_{—}ID∥HA_State) (1)

By including the HA_ID in the ICV computation, a unique per-HA token can be generated for each HA served by the SMM using a single SMM_token_key 313. SMM_token_key 313 allows SMM 310 to avoid detection of Platform_Master_Key 312 by transmitting any simple variant of Platform_Master_Key 312 which is known only to SMM 310.

Both the SMM 310 and IMM 320 may derive a Data_Sign_Key 315 and 323 from the Platform_Master_Key 312 and 322. In varying embodiments, SMM 310 and IMM 32Q may coordinate to support either a single Platform_Master_Key 312 and 322 and a single Data_Sign_Key 315 and 323 for all registered HAs, or multiple Platform_Master_Key/Data_Sign_Key pairs, one for each HA. Data_Sign_Key 312 and 322 may be used by the SMM security services module and IMM for computing and/or verifying a signature over dynamic data subject to change by a HA. Data_Sign_Key 315 and 323 may be a simple variant of Platform_Master_Key 312 and 322, although the manner deriving one from the other should be available to both the SMM 310 and the IMM 320. For example, SMM 310 and IMM 320 may both agree in advance to derive Data_Sign_Key 312 and 322 as follows:

Data_Sign_Key=hash (Platform_Master_Key∥“SMM_Security_Services”) (2)

### Where “SMM_Security_Services” is, for example, a simple string of text known only to SMM 310 and IMM 320.

The main purpose of Data_Sign_Key 315 and 323 is for computation and/or verification of a signature for a set of dynamic data modifiable by a HA supported by IMM 320. Every HA supported by IMM 320 may have a unique signature associated with one or more sets of its dynamic data and this signature must be verifiable by the IMM 320. This per-HA unique signature can be obtained by including the HA_ID 311 of the given HA while computing the cryptographic hash over the HA's set of dynamic data using the Data_Sign_Key 315. For example, the Data_Signature 316 over the HA's set of dynamic data generated by the SMM 310 is:

Data_Signature=hash (Data_Sign_Key∥HA_{—}ID∥(hash(dynamic_data))) (3)

Where “dynamic_data” represents the state of the changed set of dynamic data. There are multiple reasons for having the SMM 310 compute the signature over a hash value of the HA dynamic data buffer instead of the raw HA dynamic data. First, if dealing with the raw data, the SMM 310 would have to first translate the virtual addresses corresponding to the raw data pages into corresponding physical addresses, a process which gets complicated if the data buffers span several pages. Doing all the virtual to physical translation in SMM 310 is undesirable. Second, the time required to do keyed-hash message authentication code (HMAC) computation increases with the increase in length of the data buffers. Thus, by choosing computation of the data signature over a hash of the data buffer rather than the raw data buffers, the time spent in SMM can be significantly reduced. In an alternate embodiment however, it would certainly be acceptable to perform the hash over the entire data buffer.

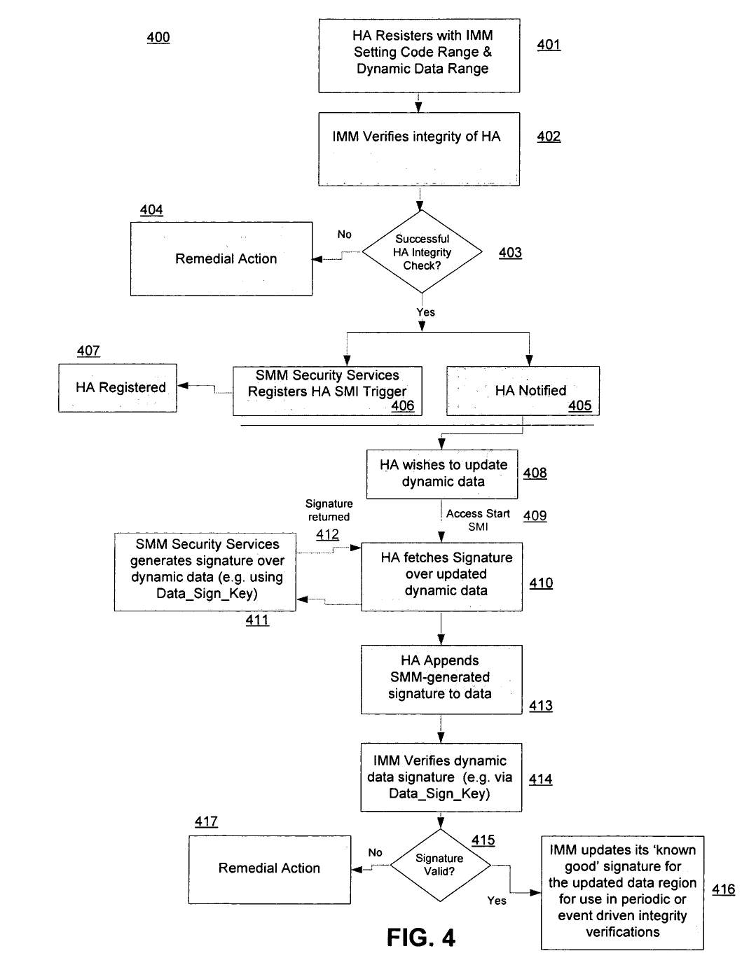

FIG. 4 is a flow diagram 400 for a method of verifying the integrity of changes to dynamic data associated with an HA. At 401, an HA registers with an IMM to avail of the integrity validation provided by the IMM. When the host agent initializes, it registers with the IMM by providing it with the range of virtual addresses that correspond to its code image. Alternately, this information could be accessed by the IMM in an integrity manifest of the HA. Additionally, the HA may also provide the IMM with the memory ranges corresponding to the critical, protected dynamic (and static) data sections. At 402, the IMM verifies the integrity of the loaded HA in memory. If the integrity of the loaded HA cannot be verified, at 404, remedial action is taken which may include but is not limited to notification of the HA and/or the SMM and/or a remote agent, removing the loaded HA form memory, shutting down the managed host on which the HA resides, etc.

Once the integrity of the host agent has been established, at 403, the IMM indicates this to the SMM Security Services module by triggering a Register SMI and providing it with an HA identifier HA_ID and the code image range, at 406. In one embodiment, the IMM may also provide the SMM with the agent locality and fixed-up hash value for agent's image and invariants relative to specific points within the agent code where an SMI is triggered. These points are herein referred to as the SMI entry points within the HA code. The SMM Security Services module may update its per-HA state table to include the newly validated HA, at 407. Additionally, the HA may be notified of the successful integrity verification, at 405.

After registration of the HA with the IMM and SMM is complete, the HA may, in the course of runtime execution, wish to update a set of dynamic data in memory, at 408. The HA may acquire permission from the SMM to change the dynamic data in response to an Access Start SMI, at 409. After permission is received and the requested changes to the dynamic data take place, the HA may fetch a signature over the updated data buffer for the dynamic data, at 410. The SMM security services may then generate a signature based at least in part on the updated set of dynamic data, at 411, and return the signature to the HA, at 412. With the signature received, the HA may append the SMM-generated signature to the dynamic data in memory, at 413. After the data signature is in memory, the IMM may verify the signature of the dynamic data, at 414.

If, at 415, the signature is determined to be invalid, then remedial action can be taken, at 417. This remedial action may include but is not limited to the remedial actions taken in 404. If the IMM finds that the signature of the dynamic data is valid, the IMM may store the signature as a “known good” signature for the updated dynamic data set. This “known good” signature may then be used by the IMM to verify the state of the dynamic data set—either periodically, or on an event-driven basis. For example, the IMM may verify that the current state of a set of dynamic data is or is not valid by comparing information derived from the latest “known good” signature for said set of dynamic data with information derived from a signature of a current state of said set of dynamic data.

In an alternate embodiment, a remote management console could request that a dynamic data region value be updated. For example, perhaps an IT administrator or other remote entity wants to change the values of certain circuit breaker filters. To do this, the administrator would send a message to the IMM, which would then generate a new ‘known-good’ ICV for the dynamic data region which it would use for future integrity verification checks. The new dynamic data values and the new ICV would then be passed to the HA for its use.

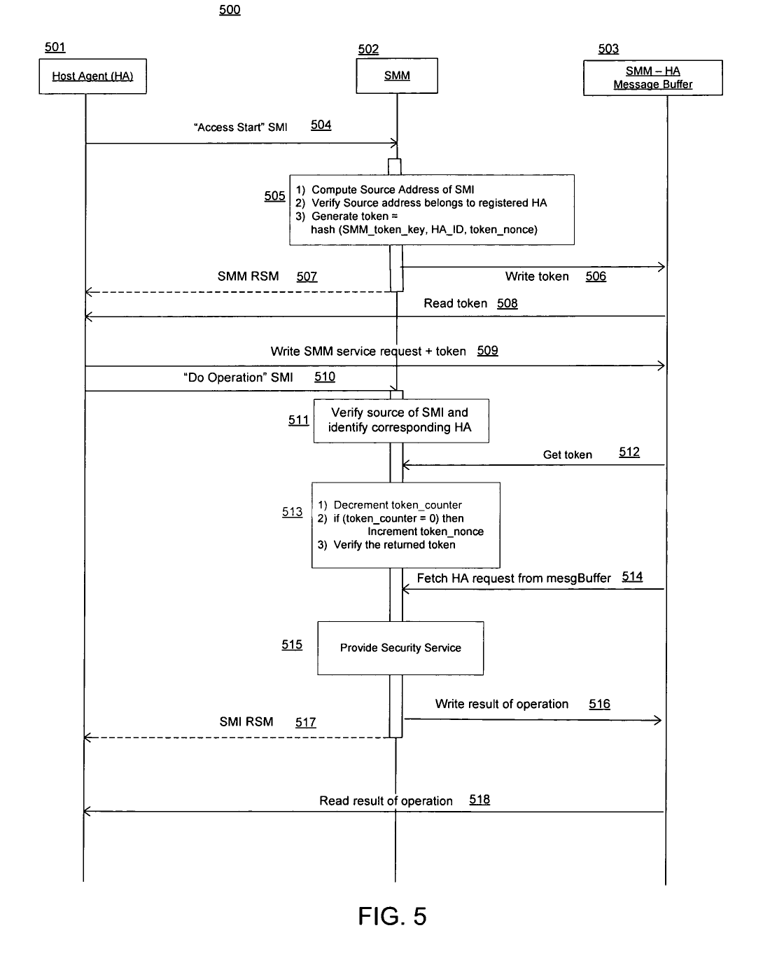

FIG. 5 is a swim lane diagram 500 illustrating a token-based protocol used to enable authorized updates to the data sections by HA 501, according to an embodiment of the invention. The use of the token-based protocol allows for reentrant and/or multi-threaded HAs to securely update their dynamic data structures. It also avoids race conditions due to context switches that may be exploited by malware without having the need to disable interrupts which can impact performance. An alternate embodiment could disable interrupts, rather than using the tokens as described in FIG. 5. The update sequence is a two stage process consisting of an “Access Start Operation” sequence and a “Do Operation” sequence.

The HA 501 initiates an Access Start Operation sequence to convey to the SMM 502 the HA's intent to request SMM security services which can be used for modifying the dynamic data. At 504, the HA 501 triggers an Access Start SMI. In response to the Access Start SMI, an SMI handler in SMM 502 validates the source of the SMI trigger and verifies that it is coming from a registered HA, at 503. In one embodiment, the SMM 502 verifies the HA 501 by validating the in-memory image corresponding to the Access Start SMI entry point against the precomputed hash value as provisioned by the IMM during registration for HA 501 at that locality. After validating the HA 501 as the source of the SMI, the SMM 502 generates a token to be used by the token to allow the HA 501 to request security services of the SMM 502. In this example, the token generated for HA 501 as follows:

token=hash(SMM_token_key∥token_nonce∥HA_{—}ID) (4)

### Where the SMM stores a token_nonce value as a representation of HA_State, discussed above in regard to per-HA token 314.

In one embodiment of the invention, SMM 502 keeps track of tokens issued to HA 501 using a counter token_counter. For each token outstanding, token_counter may be incremented for a particular HA. For each token returned by the HA, token_counter may be decremented. Once token_counter reaches zero, a new token nonce may be selected. In this example, SMM 502 increments token_counter to indicate the newly generated token for the specific HA. (e.g. token_counter=token_counter+1). At 506, the SMM 502 may write the token to a SMM-HA message buffer 503 used for communication between SMM 502 and HA 501, and sends a resume message SMM RSM 507 to HA 501. SMM RSM 507 indicates that the SMM is relinquishing some or all processor operation to the HA for updating of the dynamic data as requested, signifying the end of the “Access Start Operation” sequence.

When HA 501 has resumed and read the token 508 from the SMM-HA message buffer 503, the HA updates the dynamic data. To protect the updated dynamic data set, the HA triggers a Do Operation SMI notification, at 510. As part of this request, at 509, the HA may provide the SMM-HA message buffer 503 with the hash of the updated data sections as well as the token that was provided to it in the Access Start Operation sequence. In response to the Do Operation SMI Notification, the SMI handler in SMM 502 verifies the registered HA 501 as the source of the SMI, at 511. In one embodiment, the SMM 502 verifies the HA 501 by validating the in-memory image corresponding to the Do Operation SMI entry point against the precomputed hash value as provisioned by the IMM during registration for HA 501 at that locality. This could for example correspond to validating the page from which the Do Operation SMI was triggered.

After validating HA 501 as the source of the Do Operation SMI, SMM 502 may pick up the token from the SMM-HA message buffer 503, at 512. At 513, the SMM 502 may update the token_counter and token_nonce as necessary to track outstanding tokens associated with HA 501. In one embodiment, SMM 502 may decrement the number of outstanding tokens represented by token_counter, i.e. token_counter=token_counter−1. Then, SMM 502 may check if the outstanding token_counter is 0, indicating that there are no “open” tokens with respect to the HA. If the decremented token_counter resets to zero, SMM 502 may increment the token_nonce by 1.

At 513, SMM 502 may further verify if the token returned by the HA was the same as what was generated during the Access Start sequence. If the tokens do not match, remedial action may be taken from the SMM 502. If the tokens do match, at 514, SMM 502 may fetch the SMM service request sent to the SMM-HA message buffer 503 by the HA 501. At 515, SMM may then provide the requested security services, which may include computing a signature over the hash of the dynamic data buffers which was generated by the HA 501. An example of the signature generated by SMM 502 is as follows:

Signature=hash (Data_Sign_Key∥HA_{—}ID∥(hash(dynamic_data))) (5)

At 516, SMM 502 writes the result of the requested security operations, which may include the generated signature, to the SMM-HA message buffer 503. At 517, SMM 502 may send another SMM RSM to HA 501, indicating that the security operations have completed and runtime execution of HA 501 in a normal operating mode may resume.

At 518, HA 501 reads the result written to SMM-HA message buffer 503 by SMM 502. HA 501 may now append the signature to dynamic data in memory for use in verifying the integrity of the requested changes to the dynamic data. This signature may now be used by an IMM to verify the validity of the dynamic data in its changed state, for example as set forth in the discussion of FIG. 4. The signature value so returned by SMM 502 can be verified by the IMM that is in possession of a Data_Sign_Key. This verification of the validity may include authentication of the HA or authorized entity causing the change to the set of dynamic data and/or checking the integrity of changed state of the set of dynamic data. If an attacker modifies the set of dynamic data, the corruption may be detected by calculating for the modified data a signature, ICV or other similar value for comparison to information derived from the last “known good” value stored by the IMM. In this way, an HA or authorized agent can make authenticated and secure updates to dynamic data sections that are verifiable by an external trusted entity such as an IMM on the platform. After verifying the validity of the dynamic data update, the IMM then updates its known good version of the dynamic data for use in future integrity verification checks of the data. If an attacker were to update the dynamic data without updating the ICV in the manner described above, the IMM would detect this change during its integrity verification checks and could take remedial action.

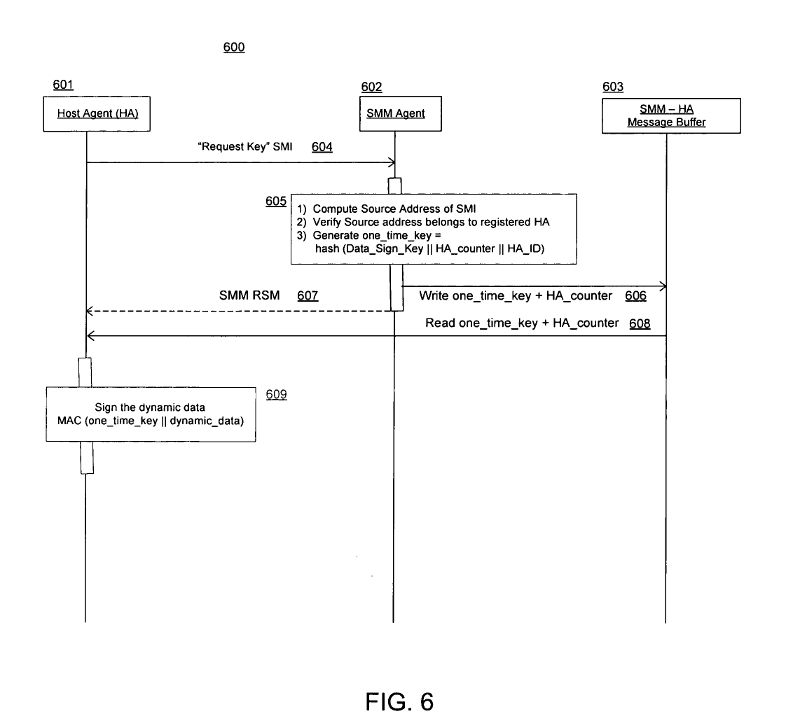

FIG. 6 is a swim lane diagram illustrating an alternate embodiment of the invention wherein the HA 601 itself could be responsible for computing the signature over the dynamic data buffers. In order to enable this to be performed in a forgery-proof manner, one or more one-time keys are generated by the SMM 602 and returned to the HA 601. According to this embodiment, during registration of HA 601, an IMM (not shown) provides SMM 602 with the HA 601 locality and fixed-up hash value for HA's image and invariants relative to specific points within the HA's code where an SMI is triggered. These points are herein referred to as the SMI entry points within the HA code.

At 604, the HA may trigger a Request Key SMI indicating that it would like to receive a one-time key (“one_time_key”). In response, at 605, the SMM may validate the source of the SMI trigger and verifies that it is coming from a registered HA. For example, the SMM 602 may validate the in-memory image corresponding to the Request Key SMI entry point against the precomputed hash value as provisioned by the IMM during registration for that agent at that locality. This could for example correspond to validating the page (or subsequent set of contiguous virtual memory pages) from which the Request Key SMI was triggered. The one_time_key may be computed as follows:

one_time_key=hash(Data_Sign_Key∥HA_counter∥HA_ID), (6)

where HA_counter is in this case a monotonically increasing counter that is maintained as a part of per HA state. In alternate embodiments, one_time_key may be generated variously by a MAC function or by a pseudo-random function, for example. SMM may then communicate one_time_key to IMM (not shown) for use in verifying the validity to changes the HA will make to the section of dynamic data. Preferably, this communication is made via a channel which is inaccessible to the HA. In one embodiment, interrupts may be disabled to prevent context switches. Note that in using one-time keys, the risk of exploits due to compromised keys is minimal. At 606, SMM 602 returns one_time_key and HA_counter to the SMM-HA message buffer 603. Then at 607, SMM 602 sends an SMM RSM to HA 601 indicating that runtime execution of HA 601 may resume. At 608, HA 601 reads one_time_key and HA_counter from SMM-HA message buffer 603. At 609, HA 601 may then sign its set of dynamic data. For example, HA may sign its dynamic data with a MAC function as follows:

Data Signature=MAC(one_time_key∥dynamic_data) (7)

This signature is appended to the dynamic data in memory to be used for integrity verification by an IMM with which HA 601 is registered, using the one_time_key which the IMM received from SMM 602. For embodiments of the invention wherein interrupts have been previously disabled, once the HA 601 has completed its operations, the HA 601 may indicate so with another SMI (not shown) to the SMM 602 which reenables interrupts.

The method described in FIG. 6 ensures that the critical sections of the HA that will operate on the keying material so returned by the SMM have not been tampered with post IMM validation. Returning keying material to the HA 601 provides the agents with the flexibility of determining how to use the keys while at the same time reduces the amount of SMM processing time.

Techniques and architectures for verifying the integrity of changes to dynamic data of a program are described herein. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions which follow are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of procedures leading to a desired result. The preocedures are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method procedures. The required structure for a variety of these systems will appear from the description below. In addition, the present invention is not described with reference to any particular programming language. It will be appreciated that a variety of programming languages may be used to implement the teachings of the invention as described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

We claim:

1. A method comprising:
changing a state of a set of data subject to change by a runtime operation of a host agent during a normal operating mode of a host system, the host agent capable of invoking one or more security operations of a management mode of the host system, during which the normal operating mode is suspended;
sharing a set of key information with the management mode of the host system and a measurement agent isolated from the host agent and in communication with the host system during the management mode of the host system; and
verifying at the measurement agent a validity of a given state of the set of data, the verifying based at least in part on the set of key information and information related to the changed state of the set of data.

2. The method of claim 1 wherein the normal operating mode is implemented in a set of one or more processors in the host system and the management mode is implemented in another set of one or more processors in the host system.

3. The method of claim 1, wherein the changing the state of the set of data includes performing an encryption operation on the set of data, and wherein verifying the validity of the given state of the set of data includes performing a decryption operation on the set of data and checking the integrity of the set of data.

4. The method of claim 1 wherein changing the state of the set of data includes calculating a data signature for a selection of the set of data which has been changed in the course of the runtime operation of the host agent, the data signature based at least in part on the set of key information, and writing the data signature in the set of data.

5. The method of claim 4 wherein calculating the data signature includes at least one of calculating a hash over the selection of the set of data, and calculating a message authentication code (MAC) function over the selection of the set of data.

6. The method of claim 4 further comprising:
calculating a second data signature based at least in part on the given state of the set of data, and
wherein the verifying the validity of the given state of the set of data is based at least in part on a comparison of information related to the data signature to information related to the second data signature.

7. The method of claim 4 further comprising:
receiving at the host agent a one-time key from the management mode; and
receiving at the management agent information related to the one-time key,
wherein the data signature is calculated by the host agent using the one-time key, and
wherein the verifying the validity of the given state of the set of data is further based on the received information related to the one-time key.

8. The method of claim 1, wherein the management mode has a protected region of a memory that is inaccessible to the host agent, the method further comprising:
invoking the one or more security services of the management mode to generate information in the protected region of the memory, the information to determine at least in part the changed state of the set of data.

9. The method of claim 1 wherein verifying the validity of the given state of the set of data includes at least one of authenticating an agent associated with the given state of the set of data, and checking the integrity of the given state of the set of data.

10. The method of claim 9 wherein authenticating the agent associated with the given state of the set of data includes at least one of
verifying a location in memory of a code image of the agent, and
validating an integrity of the code image of the agent.

11. The method of claim 1 wherein the changing the state of the set of data is in response to an operation of an agent other than the host agent.

12. The method of claim 1 further comprising: requesting from the management mode an authorization of the changing the state of the set of data, the requesting via a token-based protocol.

13. An apparatus comprising:
a host system having
a host agent,
a normal operating mode during which the host agent may perform a runtime operation,
a management mode during which the normal operating mode is suspended, the management mode to provide one or more security services to the host agent, and
a set of data subject to change based at least in part on a performance of the runtime operation of the host agent during the normal operating mode of a host system; and
a measurement agent isolated from the host agent and in communication with the host system during a management mode of the host system, the measurement agent to share a set of key information with the management mode, the measurement agent further to verify a validity of a given state of the set of data based at least in part on the set of key information and information related to a changed state of the set of data.

14. The apparatus of claim 13, the host system to perform an encryption operation on the set of data, and wherein verifying the validity of the given state of the set of data includes performing a decryption operation on the set of data, and checking the integrity of the set of data.

15. The apparatus of claim 13, the host system to calculate a data signature for a selection of the set of data which has been changed in the course of the runtime operation of the host agent, the data signature based at least in part on the set of key information, and the host system further to write the data signature in the set of data.

16. The apparatus of claim 13, the management mode further to generate information in a protected region of a memory that is inaccessible to the host agent, the information to determine at least in part the changed state of the set of data.

17. The apparatus of claim 13, wherein verifying the validity of the given state of the set of data includes at least one of verifying a location in memory of a code image of an agent associated with the given state of the set of data, validating an integrity of the code image of the agent, and checking the integrity of the given state of the set of data.

18. An system comprising:
a host system having
a host agent,
a normal operating mode during which the host agent may perform a runtime operation,
a management mode during which the normal operating mode is suspended, the management mode to provide one or more security services to the host agent, and
a set of data subject to change based at least in part on a performance of the runtime operation of the host agent during the normal operating mode of a host system;
a measurement agent isolated from the host agent and in communication with the host system during a management mode of the host system, the measurement agent to share a set of key information with the management mode, the measurement agent further to verify a validity of a given state of the set of data based at least in part on the set of key information and information related to a changed state of the set of data; and
a serial bus connector coupled to the host system to communicate data to the measurement agent.

19. The system of claim 18, the host system to perform an encryption operation on the set of data, and wherein verifying the validity of the given state of the set of data includes performing a decryption operation on the set of data, and checking the integrity of the set of data.

20. The system of claim 18, the host system to calculate a data signature for a selection of the set of data which has been changed in the course of the runtime operation of the host agent, the data signature based at least in part on the set of key information, and the host system further to write the data signature in the set of data.

21. The system of claim 18, the management mode further to generate information in a protected region of a memory that is inaccessible to the host agent, the information to determine at least in part the changed state of the set of data.

22. The system of claim 18, wherein verifying the validity of the given state of the set of data includes at least one of verifying a location in memory of a code image of an agent associated with the given state of the set of data, validating an integrity of the code image of the agent, and checking the integrity of the given state of the set of data.

23. A machine-readable medium that provides instructions, which when executed by a set of one or more processors, cause said set of processors to perform a method comprising:
changing a state of a set of data subject to change by a runtime operation of a host agent during a normal operating mode of a host system, the host agent capable of invoking one or more security operations of a management mode of the host system during which the normal operating mode is suspended;
sharing a set of key information with the management mode of the host system and a measurement agent isolated from the host agent and in communication with the host system during the management mode of the host system; and
verifying at the measurement agent a validity of a given state of the set of data, the verifying based at least in part on the set of key information and information related to the changed state of the set of data.

24. The machine-readable medium of claim 23, wherein the changing the state of the set of data includes performing an encryption operation on the set of data, and wherein verifying the validity of the given state of the set of data includes performing a decryption operation on the set of data, and checking the integrity of the set of data.

25. The machine-readable medium of claim 23 wherein changing the state of the set of data includes
calculating a data signature for a selection of the set of data which has been changed in the course of the runtime operation of the host agent, the data signature based at least in part on the set of key information, and
writing the data signature in the set of data.

26. The machine-readable medium of claim 25, the method further comprising:
calculating a second data signature based at least in part on the given state of the set of data, and
wherein the verifying the validity of the given state of the set of data is based at least in part on a comparison of information related to the data signature to information related to the second data signature.

27. The machine-readable medium of claim 25, the method further comprising:
receiving at the host agent a one-time key from the management mode; and
receiving at the management agent information related to the one-time key,
wherein the data signature is calculated by the host agent using the one-time key, and
wherein the verifying the validity of the given state of the set of data is further based on the received information related to the one-time key.

28. The machine-readable medium of claim 23, wherein the management mode has a protected region of a memory that is inaccessible to the host agent, the method further comprising:
invoking the one or more security services of the management mode to generate information in the protected region of the memory, the information to determine at least in part the changed state of the set of data.

29. The machine-readable medium of claim 23 wherein verifying the validity of the given state of the set of data includes at least one of authenticating an agent associated with the given state of the set of data, and checking the integrity of the given state of the set of data.

30. The machine-readable medium of claim 29 wherein authenticating the agent associated with the given state of the set of data includes at least one of
verifying a location in memory of a code image of the agent, and
validating an integrity of the code image of the agent.
